(19) United States
(12) Patent Application Publication
(10) Pub. No.: US 2007/0053413 A1
(43) Pub. Date: Mar. 8, 2007

(54) METHOD AND APPARATUS FOR OPTIMIZING RADIO FREQUENCY COMMUCATION

(76) Inventor: Mu-Chuan Lee, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 11/306,363

(22) Filed: Dec. 26, 2005

(30) Foreign Application Priority Data
Sep. 6, 2005 (TW) 094130612

(51) Int. Cl. H04B 1/00

(52) U.S. Cl. 375/140

(57) ABSTRACT

A method for radio frequency communication includes activating a button of a wireless device; the wireless device detecting a data error rate of each of a plurality of radio frequency channels according to a first predetermined parameter; the wireless device comparing the data error rate of each of the plurality of radio frequency channels; and setting one of the plurality of radio frequency channels having a lower data error rate as a formal transmitting channel of the wireless device.

### BACKGROUND OF THE INVENTION

1. Field of the Invention

The present invention relates to a method for radio frequency communication, and more particularly, to a method for optimizing radio frequency communication.

2. Description of the Prior Art

As the radio frequency technology advances rapidly, various types of wireless devices are developed to satisfy user demand. Industrial Science Medical (ISM) band is a radio frequency band that doesn't need to apply for a license while in use. Because the ISM band is common globally, especially the band of 2.4 GHz (2.40 GHz-2.4835 GHz), many wireless products, such as Bluetooth devices, walkie-talkies, wireless phones, or even microwaves operate in the 2.4 GHz ISM band, such that the wireless products can be sold globally and also be mass produced for decreasing the manufacturing cost. However, the more wireless products communicate in 2.4 GHz ISM band, the more interference occurs, and thus cause transmission delay and data loss.

To prevent interference or wiretap due to using the same radio frequency band, a spread spectrum technique is applied to the wireless products for data transmission. Please refer to FIG. 1, which shows the spread spectrum technique of the prior art spreading a bandwidth of a signal. The spread spectrum technique spreads the bandwidth of a signal of transmission data to a wider bandwidth before transmitting, and then recovers the bandwidth of the spread signal to the original bandwidth while receiving. Generally, there are two types of spread spectrum techniques: direct sequence spread spectrum (DSSS) technique and frequency hopping spread spectrum (FHSS) technique.

The direct sequence spread spectrum technique divides a data bit into to a plurality of spreading codes according to a pseudo noise code (PN code) while transmitting data. For example, as shown in FIG. 2, the direct sequence spread spectrum technique encodes a fundamental data bit“1”to ten spreading codes “1011011101”according to a pseudo noise code, and encodes a fundamental data bit“0”to ten spreading codes “0100100010”(that is the opposite number of “1011011101”).

The frequency hopping spread spectrum technique changes a data transmission channel with time according to a pseudo noise code. For example, as shown in FIG. 3, the frequency hopping spread spectrum technique sets a sequence of data transmission channels according to a pseudo noise code, such as transmitting a data bit A by channel “2” at time “1”, transmitting a data bit B, by channel “5” at time “2”, transmitting a data bit C by channel“4” at time “3”, and so forth.

A pseudo noise code looks random but has a periodic sequence. To transmit data successfully, both the transmitting end and the receiving end must have the identical and synchronous pseudo noise code, such that the receiving end can recover the spread signal according to the pseudo noise code. In addition, the transmitting end and the receiving end also can communicate according to an identified number and an identified code (such like encryption code). The identified number is for recognizing data, and the identified code is for encrypting data to increase security. The above two methods are well known by those skilled in the art, and therefore not described further.

Although the spread spectrum technique can prevent interference, it still may face problems of transmission delay and data loss. To solve the problem of data loss, when the transmitting quality of a radio frequency channel is bad, the prior art will switch to another radio frequency channel or resend data. However, switching the radio frequency channel or resending data too frequently will cause more serious delay, moreover, the prior art only follows a predetermined procedure to switch the radio frequency channel automatically without interacting with the user. Thus, the prior art is unable to optimize the radio frequency communication according to the environment at the time.

### SUMMARY OF THE INVENTION

It is therefore an objective of the claimed invention to provide a method for optimizing radio frequency communication in order to solve the problems of the prior art.

The present invention provides a method for optimizing radio frequency communication that includes detecting a data error rate of each of a plurality of radio frequency channels according to a first predetermined parameter; comparing the data error rate of each of the plurality of radio frequency channels; and setting one of the plurality of radio frequency channels having a lower data error rate as a formal transmitting channel.

In addition, the present invention provides a related apparatus for performing the method of the present invention by activating a button. Therefore, the present invention not only brings convenience and flexibility in use, but also increases interaction between a user and a wireless system.

A radio frequency communication method of the present invention comprises activating a button of a wireless device; the wireless device detecting a data error rate of each of a plurality of radio frequency channels according to a first predetermined parameter; the wireless device comparing the data error rate of each of the plurality of radio frequency channels; and setting one of the plurality of radio frequency channels having a lower data error rate as a formal transmitting channel of the wireless device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing the spread spectrum technique of the prior art spreading a bandwidth of a signal.

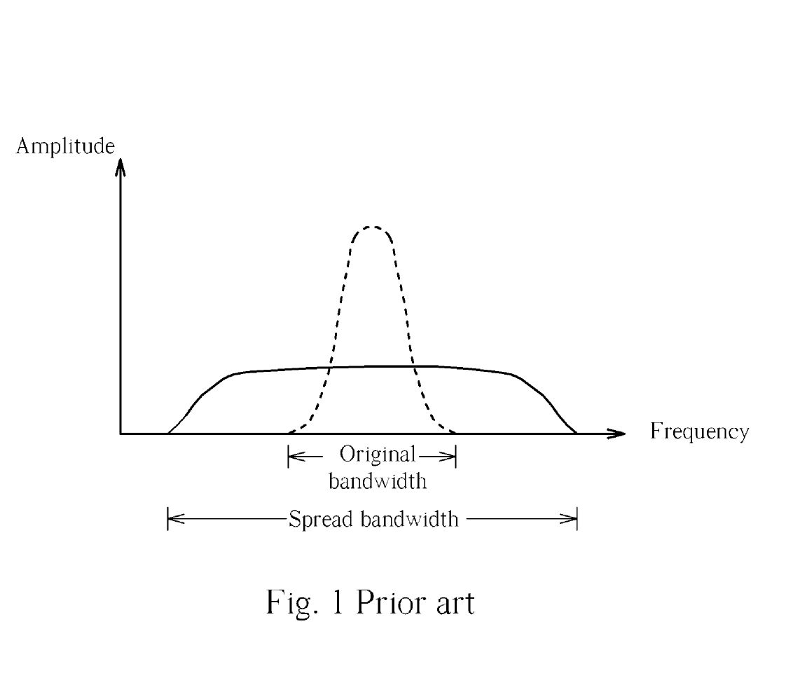

FIG. 2 is a diagram showing the direct sequence spread spectrum technique of the prior art dividing a data bit into to a plurality of spreading codes.

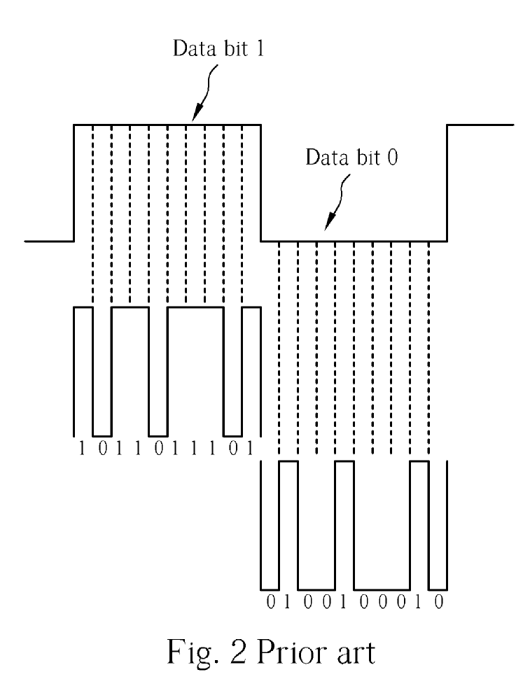

FIG. 3 is a diagram showing the frequency hopping spread spectrum technique of the prior art switching radio frequency channels with time.

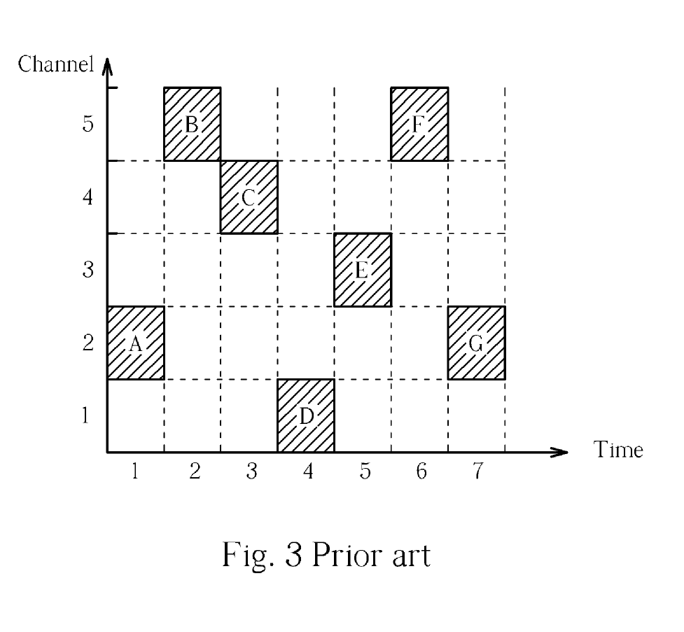

FIG. 4 is a diagram showing the wireless system of the present invention.

FIG. 5 is a flow chart showing the method of the present invention.

### DETAILED DESCRIPTION

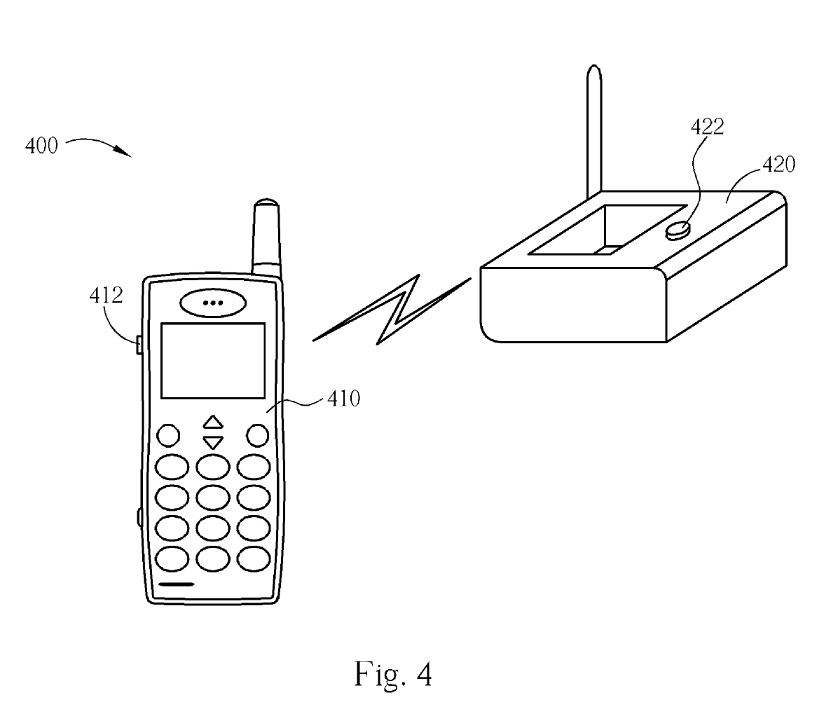

Please refer to FIG. 4, which shows a wireless system 400 of the present invention. The wireless system 400 of the present invention optimizes the radio frequency communication by detecting a data error rate of each radio frequency channels between a remote end 410 and a host end 420. For example, the 2.4 GHz ISM band comprises 79 radio frequency channels, and the wireless system 400 of the present invention can detect the data error rate of each of the 79 radio frequency channels according to a first set of predetermined parameters. Suppose the first set of predetermined parameters comprise a first pseudo noise code, the host end 420 can transmit a specific word string to the remote end 410 via a first channel according to the first pseudo noise code. Thereafter, the remote end 410 sends back the specific word string to the host end 420 via the first channel according to the first pseudo noise code, such that the host end 420 can compare the specific word string from the remote end 410 with the original specific word string in order to find out and store the data error rate of the first channel under the first set of predetermined parameters. Then the wireless system 400 can detect and store a data error rate of the second channel according to the first set of predetermined parameters, and so forth. After recording data error rates of all radio frequency channels under the first set of predetermined parameters, the wireless system 400 can compare the data error rate of each of the 79 radio frequency channels to figure out which radio frequency channel has a lower data error rate under the first set of predetermined parameters, and sets the channel having a lower data error rate as a formal transmitting channel of the wireless system 400, therefore optimizes the radio frequency communication between the remote end 410 and the host end 420.

In addition, the present invention further can detect a data error rate of each of the 79 radio frequency channels according to a second set of predetermined parameters (such as a second pseudo noise code), or even according to more sets of predetermined parameters, then compares the data error rates of each of the 79 radio frequency channels under the plurality of sets of predetermined parameters to find out which radio frequency channel with which set of predetermined parameters have a lowest data error rate, and sets the radio frequency channel and the set of predetermined parameters as a formal transmitting channel and formal transmitting parameters of the wireless system 400. The above method also can apply to other ISM band products using bidirectional communication protocol.

Each set of predetermined parameters may not only comprise a pseudo noise code, but also comprises other communication parameters, such as an identified number and an identified code (such like encryption code). The main thing is data error rates of a plurality of radio frequency channels should be detected according to one or more sets of predetermined parameters, and then the detected data error rates should be compared to set one of the plurality of radio frequency channels with one set of the predetermined parameters having a lower data error rate as a formal transmitting channel and formal transmitting parameters.

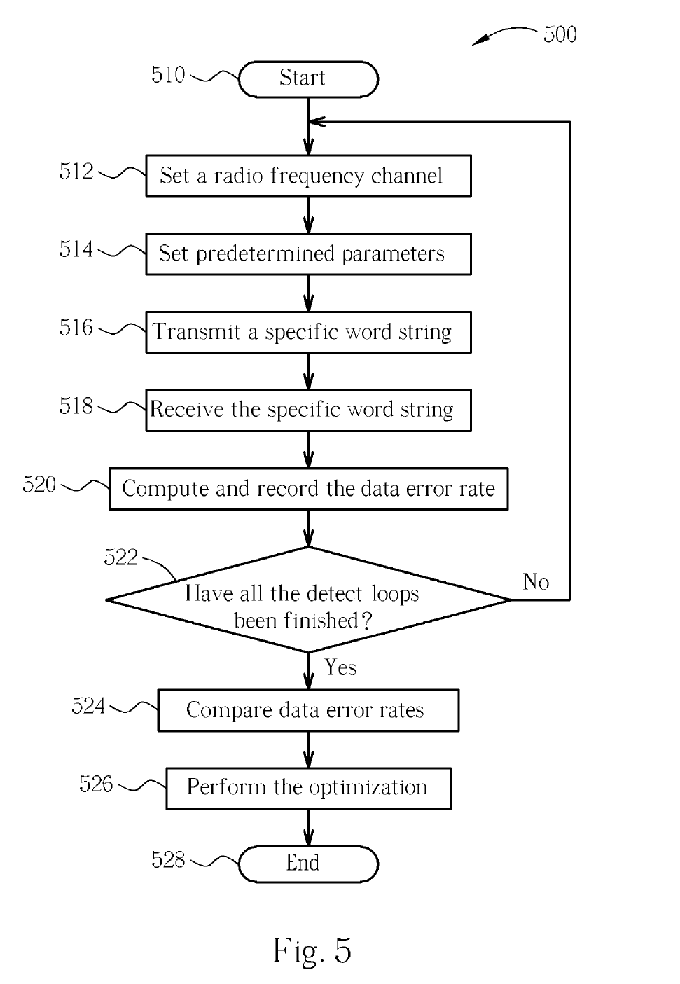

For illustrating the method of optimizing the radio frequency communication more clearly, FIG. 5 provides a flowchart 500 of the method of the present invention. Please refer to FIG. 5, and refer to FIG. 4 as well; the flowchart 500 of FIG. 5 comprises the following steps:

Step 510: Start;

Step 512: Set a radio frequency channel;

Step 514: Set a set of predetermined parameters, such as a pseudo noise code, an identified number, and an identified code;

Step 516: Transmit a specific word string via the radio frequency channel according to the set of predetermined parameters;

Step 518: Receive the specific word string via the radio frequency channel according to the set of predetermined parameters;

Step 520: Compute and record the data error rate;

Step 522: Check whether all the detect-loops have been finished, if not, go back to step 512, if so, go to step 524;

Step 524: Compare the data error rate of each combination of all the radio frequency channels and predetermined parameters;

Step 526: Set one of the plurality of radio frequency channels with one set of the predetermined parameters having a lower data error rate as a formal transmitting channel and formal transmitting parameters in order to perform the optimization of radio frequency communication;

Step 528: End.

Basically, to achieve the same result, the steps of the flowchart 500 need not be in the exact order shown and need not be contiguous, that is, other steps can be inserted between. In addition, the method of the present invention can be performed by software, hardware, firmware, or any combination of the above.

Summarizing the above, the present invention compares the data error rate of each combination of all the radio frequency channels and predetermined parameters, and sets one of the plurality of radio frequency channels with one set of the predetermined parameters having a lower data error rate as a formal transmitting channel and formal transmitting parameters in order to perform the optimization of radio frequency communication. In the preferred embodiment of the present invention, the above optimization can be performed by a user pushing a button 412 of the remote end 410 or a button 422 of the host end 420 to (as shown in FIG. 4), or be executed automatically by the remote end 410 or the host end 420 while the wireless system 400 is booted. In addition, after comparing the data error rate of each combination of the radio frequency channels and predetermined parameters, the wireless system 400 of the present invention can list out several combinations having the lowest data error rates to let the user select one of the above combinations as the formal transmitting channel and formal transmitting parameters.

In contrast to the prior art, the present invention provides a method and related apparatus for optimizing radio frequency communication. The present invention sets a radio frequency channel with a set of predetermined parameters having a lower data rate as the formal transmitting channel and formal transmitting parameters, therefore the wireless system 400 can transmit data by the optimized radio frequency channel and predetermined parameters according to the environment at the time. Even though the overall communication quality is bad, the wireless system 400 can still work in the best condition without switching radio frequency channels too frequently like the prior art, and thus prevents the serious transmission delay. Besides, when the user wants to improve the communication quality, the user can easily push a button to perform the optimization of the present invention, and even can choose one of the combinations of radio frequency channels and predetermined parameters having the lowest data error rates as the formal transmitting channel and formal transmitting parameters. Therefore, the present invention not only brings convenience and flexibility in use, but also increases interaction between a user and the wireless system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for optimizing radio frequency communication, the method comprising the following steps:
(a) detecting a data error rate of each of a plurality of radio frequency channels according to a first predetermined parameter;
(b) comparing the data error rate of each of the plurality of radio frequency channels; and
(c) setting one of the plurality of radio frequency channels having a lower data error rate as a formal transmitting channel according to the comparing result of step (b).

2. The method of claim 1 wherein the first predetermined parameter comprises a first pseudo noise code (PN code), step (a) comprising detecting a data error rate of each of a plurality of radio frequency channels according to the first pseudo noise code.

3. The method of claim 1 wherein the first predetermined parameter comprises a first identified number, step (a) comprising detecting a data error rate of each of a plurality of radio frequency channels according to the first identified number.

4. The method of claim 1 wherein the first predetermined parameter comprises a first identified code, step (a) comprising detecting a data error rate of each of a plurality of radio frequency channels according to the first identified code.

5. The method of claim 1 further comprising step (d) detecting a data error rate of each of the plurality of radio frequency channels according to a second predetermined parameter, wherein step (b) comprises comparing the data error rate of each of the plurality of radio frequency channels under the first and second parameters.

6. The method of claim 5 wherein step (c) comprises setting one of the plurality of radio frequency channels with one of the predetermined parameters having a lower data error rate as a formal transmitting channel and a formal transmitting parameter according to the comparing result of step (b).

7. The method of claim 5 wherein the second predetermined parameter comprises a second pseudo noise code (PN code), step (d) comprising detecting a data error rate of each of a plurality of radio frequency channels according to the second pseudo noise code.

8. The method of claim 5 wherein the second predetermined parameter comprises a second identified number, step (d) comprising detecting a data error rate of each of a plurality of radio frequency channels according to the second identified number.

9. The method of claim 5 wherein the second predetermined parameter comprises a second identified code, step (d) comprising detecting a data error rate of each of a plurality of radio frequency channels according to the second identified code.

10. The method of claim 1 wherein the plurality of radio frequency channels are channels of the Industry Science Medical (ISM) band.

11. A method for optimizing radio frequency communication, the method comprising the following steps:
(a) activating a button of a wireless device;
(b) the wireless device detecting a data error rate of each of a plurality of radio frequency channels according to a first predetermined parameter;
(c) the wireless device comparing the data error rate of each of the plurality of radio frequency channels; and
(d) setting one of the plurality of radio frequency channels having a lower data error rate as a formal transmitting channel of the wireless device according to the comparing result of step (c).

12. The method of claim 11 wherein the first predetermined parameter comprises a first pseudo noise code (PN code), step (b) comprising the wireless device detecting a data error rate of each of a plurality of radio frequency channels according to the first pseudo noise code.

13. The method of claim 11 wherein the first predetermined parameter comprises a first identified number, step (b) comprising the wireless device detecting a data error rate of each of a plurality of radio frequency channels according to the first identified number.

14. The method of claim 11 wherein the first predetermined parameter comprises a first identified code, step (b) comprising the wireless device detecting a data error rate of each of a plurality of radio frequency channels according to the first identified code.

15. The method of claim 11 further comprising step (e) the wireless device detecting a data error rate of each of the plurality of radio frequency channels according to a second predetermined parameter, wherein step (c) comprises the wireless device comparing the data error rate of each of the plurality of radio frequency channels under the first and second parameters.

16. The method of claim 15 wherein step (d) comprises setting one of the plurality of radio frequency channels with one of the predetermined parameters having a lower data error rate as a formal transmitting channel and a formal transmitting parameter of the wireless device according to the comparing result of step (c).

17. The method of claim 15 wherein the second predetermined parameter comprises a second pseudo noise code (PN code), step (e) comprising the wireless device detecting a data error rate of each of a plurality of radio frequency channels according to the second pseudo noise code.

18. The method of claim 15 wherein the second predetermined parameter comprises a second identified number, step (e) comprising the wireless device detecting a data error rate of each of a plurality of radio frequency channels according to the second identified number.

19. The method of claim 15 wherein the second predetermined parameter comprises a second identified code, step (e) comprising the wireless device detecting a data error rate of each of a plurality of radio frequency channels according to the second identified code.

20. The method of claim 11 wherein the plurality of radio frequency channels are channels of the Industry Science Medical (ISM) band.
